(19) United States
(12) Patent Application Publication
(10) Pub. No.: US 2019/0061604 A1
(43) Pub. Date: Feb. 28, 2019

(54) LIGHTING DEVICE AND METHOD

(71) Applicants: BOE TECHNOLOGY GROUP CO., LTD., Beijing (CN); ORDOS YUANSHENG OPTOELECTRONICS CO., LTD., Inner Mongolia (CN)

(72) Inventors: Huijuan WANG, Beijing (CN); Xue DONG, Beijing (CN); Dan WANG, Beijing (CN); Yun QIU, Beijing (CN); Xiangdong WEI, Beijing (CN); Fei WANG, Beijing (CN); Xiao SUN, Beijing (CN)

(73) Assignees: BOE TECHNOLOGY GROUP CO., LTD., Beijing (CN); ORDOS YUANSHENG OPTOELECTRONICS CO., LTD., Inner Mongolia (CN)

(21) Appl. No.: 15/567,409

(22) PCT Filed: Apr. 18, 2017
(86) PCT No.: PCT/CN2017/080908

§ 371 Date: Oct. 18, 2017

(30) Foreign Application Priority Data
May 20, 2016 (CN) 201610341640.8

(51) Int. Cl. B60Q 1/08; F21V 23/00; F21S 41/64

(52) U.S. Cl. CPC B60Q 1/085; F21W 2107/10; F21S 41/645; F21V 23/003

(57) ABSTRACT

The present disclosure provides a lighting device and method. The device includes a lighting module configured to generate light required for illumination; a processing module configured to determine a target illumination area based on one or more environmental factors around the lighting device; and a lighting control module configured to project light emitted from the lighting module to the target illumination area. The method includes determining a target illumination area based on one or more environmental factors; and controlling, by a lighting control module, a lighting module to generate and project light to the target illumination area.

### CROSS-REFERENCE TO RELATED APPLICATION

This application claims a priority to Chinese Patent Application No. 201610341640.8 filed on May 20, 2016, the disclosures of which are incorporated in their entirety by reference herein.

### TECHNICAL FIELD

The present disclosure relates to the field of lighting technology, in particular to a lighting device and method.

### BACKGROUND

Lighting devices, which are widely used in people's production and life and other fields, are indispensable tools in the life. In many practical environments, lighting conditions play an important role in the quality of life and safety.

For example, vehicles such as automobiles need lighting devices to ensure safe driving at night or in weak light conditions. In the case of automobiles for example, acting as the automobile's “eyes”, headlamps are responsible for the lighting work at night, and include both high-beam headlamps and low-beam headlamps. The high-beam and low-beam headlamps exhibit different irradiation heights and distances. In general, the low-beam headlamp exhibits a low irradiation height, an irradiation distance of about 30 to 40 meters, and an irradiation range of about 160 degrees, while the high-beam headlamp exhibits relatively concentrated light rays and a high irradiation height, and may provide light to reach 200 to 600 meters away depending on the type of the headlamp. There is a direct relationship between the use of automobile lights and safe driving and civilized driving, and proper use of the automobile lights can not only protect the safety of the automobile itself, but also create an orderly traffic environment. Especially at night or in poor weather conditions, there is an increased need for the driver to timely switch between the high-beam and low-beam headlamps, which actually means the switching of the height and distance of illumination of the headlamps, and can be attributed to the change of the illumination direction of the headlamps.

Switches for switching between the high-beam and low-beam headlamps of an automobile in related art include a lever type, a button type, etc, and require manual operation, and frequent switching between the high-beam and low-beam headlamps in complex road conditions may be burdensome to the driver.

### SUMMARY

In view of this, the present disclosure provides a lighting device and method capable of improving the flexibility of illumination and safety.

To achieve this object, the lighting device provided in the present disclosure includes a lighting module configured to generate light required for illumination; a processing module configured to determine a target illumination area based on one or more environmental factors around the lighting device; and a lighting control module configured to project light emitted from the lighting module to the target illumination area.

In one possible embodiment of the present disclosure, the processing module includes an environmental factor acquisition unit configured to acquire the one or more environmental factors; and an environmental factor calculation unit configured to calculate the one or more environmental factors so as to determine the target illumination area.

In one possible embodiment of the present disclosure, the environmental factor acquisition unit includes an infrared detection mechanism configured to detect the one or more environmental factors by infrared light rays.

In one possible embodiment of the present disclosure, the environmental factor acquisition unit includes a photographing mechanism configured to photograph the one or more environmental factors.

In one possible embodiment of the present disclosure, the lighting control module includes a liquid crystal lens provided on a light-exiting surface of the lighting module; and a liquid crystal control unit configured to control liquid crystal in the liquid crystal lens to be deflected such that light passing through the liquid crystal lens is deflected to reach the target illumination area.

In one possible embodiment of the present disclosure, the liquid crystal lens includes a plurality of sub-units, and the lighting control module drives liquid crystal molecules of each of the sub-units to be deflected.

In one possible embodiment of the present disclosure, the lighting device includes light sources arranged in the form of an array with a predetermined density.

In one possible embodiment of the present disclosure, the lighting device is applied to a vehicle.

In one possible embodiment of the present disclosure, if the one or more environmental factors indicate a state in which there will be one or more oncoming vehicles within a predetermined time period, the target illumination area determined by the processing module is an area to which light rays projected are not directed towards the eyes of one or more drivers in the one or more oncoming vehicles.

In one possible embodiment of the present disclosure, if the one or more environmental factors indicate that there are one or more oncoming pedestrians ahead of the vehicle, the target illumination area determined by the processing module is an area to which light rays projected are not directed towards the eyes of the one or more oncoming pedestrians.

In one possible embodiment of the present disclosure, if the one or more environmental factors indicate a state in which the vehicle is about to turn a corner within a predetermined time period, the target illumination area determined by the processing module is an area which conforms with a bending trend of the road.

In one possible embodiment of the present disclosure, if the one or more environmental factors indicate a state in which the vehicle is about to travel uphill or downhill within a predetermined time period, the target illumination area determined by the processing module is an area which conforms with an uphill or downhill trend of the road.

In another aspect, the present disclosure provides a vehicle including the lighting device provided in any of the embodiments of the present disclosure.

Further, the present disclosure provides a lighting method including steps of: determining a target illumination area based on one or more environmental factors; and controlling, by a lighting control module, a lighting module to generate and project light to the target illumination area.

In one possible embodiment of the present disclosure, the step of determining the target illumination area based on the one or more environmental factors includes steps of: acquiring the one or more environmental factors; and calculating the one or more environmental factors to determine the target illumination area.

In one possible embodiment of the present disclosure, the lighting control module comprises a liquid crystal lens provided on a light-exiting surface of the lighting module; and the step of controlling, by the lighting control module, the lighting module to generate and project light to the target illumination area includes: controlling liquid crystal in the liquid crystal lens to be deflected such that light passing through the liquid crystal lens is deflected at a desired angle to reach the target illumination area.

In one possible embodiment of the present disclosure, the step of acquiring the one or more environmental factors includes detecting the one or more environmental factors by infrared light rays.

In one possible embodiment of the present disclosure, the step of acquiring the one or more environmental factors includes photographing the one or more environmental factors by means of a photographing mechanism.

In one possible embodiment of the present disclosure, the liquid crystal lens consists of a plurality of sub-units, and the step of controlling the lighting module to project the light to the target illumination area includes driving liquid crystal molecules of each of the sub-units to be deflected such that the light is projected to the target illumination area.

In one possible embodiment of the present disclosure, the method is applied to a vehicle.

In one possible embodiment of the present disclosure, if the one or more environmental factors indicate a state in which there will be one or more oncoming vehicles within a predetermined time period, the determined target illumination area is an area to which light rays projected are not directed towards the eyes of one or more drivers in the one or more oncoming vehicles.

In one possible embodiment of the present disclosure, if the one or more environmental factors indicate that there are one or more oncoming pedestrians ahead of the vehicle, the determined target illumination area is an area to which light rays projected are not directed towards the eyes of the one or more oncoming pedestrians.

In one possible embodiment of the present disclosure, if the one or more environmental factors indicate a state in which the vehicle is about to turn a corner within a predetermined time period, the target illumination area is an area which conforms with a bending trend of the road.

In one possible embodiment of the present disclosure, if the one or more environmental factors indicate a state in which the vehicle is about to travel uphill or downhill within a predetermined time period, the target illumination area is an area which conforms with an uphill or downhill trend of the road.

As can be seen from the above, the lighting device and method provided in embodiments of the present disclosure are capable of determining the target illumination area based on the one or more environmental areas and changing the light-exiting direction of light emitted from the light source to allow the light to reach the target illumination area, thus making it possible to ensure that the illumination state conforms with the needs and improve the flexibility and safety of illumination. In the embodiments of the present disclosure, the liquid crystal lens is applied to the lighting device. As a result, it is able to quickly change the light-exiting direction by controlling voltage of the power supply.

### BRIEF DESCRIPTION OF THE DRAWINGS

FIG. 1 is a structural schematic view of a lighting device according to an embodiment of the present disclosure;

FIG. 2 is a schematic view of a liquid crystal lens according to an embodiment of the present disclosure;

FIG. 3 is a schematic view of changing a target illumination area according to an embodiment of the present disclosure; and

FIG. 4 is a schematic view showing a flow chart according to an embodiment of the present disclosure.

### DETAILED DESCRIPTION

To make the technical problems to be solved, technical solutions and advantages of the present disclosure more apparent, the present disclosure will be described below in detail in conjunction with the drawings and specific embodiments.

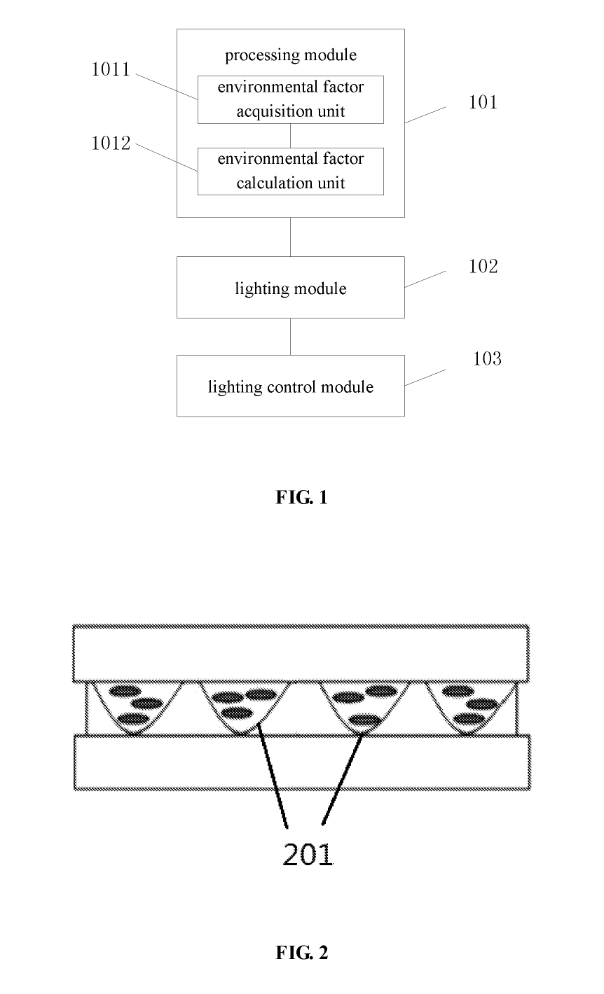

First, the present disclosure provides a lighting device including a processing module 101, a lighting module 102 and a lighting control module 103 as shown in FIG. 1. The processing module 101 is configured to determine a target illumination area based on one or more environmental factors around the lighting device. The lighting module 102 is configured to generate light required for illumination. And the lighting control module 103 is configured to project light emitted from the lighting module 102 to the target illumination area.

As can be seen from the above, the lighting device provided in the present disclosure is capable of determining the target illumination area based on the one or more environmental factors around the lighting device such that the illumination range can be adjusted based on human activities in the surrounding environment, weather factors, etc., resulting in the comfort and flexibility of illumination improved. Meanwhile, it is further possible to improve the safety of illumination by applying the lighting device provided in the present disclosure to industries in which illumination is closely related to safety, such as transportation.

In specific embodiments of the present disclosure, the one or more environmental factors include human activity factors and animal activity factors. For example, in the case where the lighting device of the present disclosure is applied to the field of transportation, the one or more environmental factors are present states of one or more pedestrians or present states of one or more animals. Specifically, the one or more environmental factors may be positions of the one or more pedestrians, positions of the one or more animals' activities, and so forth.

In a specific embodiment of the present disclosure, when the lighting device of the present disclosure is applied to the field of transportation, the one or more environmental factors include road conditions, aviation conditions, water conditions in which the lighting device is located, and so forth.

In some embodiments of the present disclosure, still referring to FIG. 1, the processing module 101 includes an environmental factor acquisition unit 1011 and an environmental factor calculation unit 1012. The environmental factor acquisition unit 1011 is configured to acquire the one or more environmental factors. And the environmental factor calculation unit 1012 is configured to calculate the one or more environmental factors so as to determine the target illumination area.

In specific embodiments of the present disclosure, the environmental factor acquisition unit acquires the one or more environmental factors by means of at least one of an infrared detection mechanism, an ultrasonic detection mechanism, and a photographing mechanism. When the lighting device provided in the present disclosure is applied to a vehicle, the environmental factor acquisition unit may acquire the one or more environmental factors from a driver assistance system or the like.

In some embodiments of the present disclosure, the environmental factor acquisition unit includes an infrared detection mechanism configured to detect the one or more environmental factors by infrared light rays.

In some embodiments of the present disclosure, the environmental factor acquisition unit includes a photographing mechanism configured to photograph the one or more environmental factors.

In some embodiments of the present disclosure, the environmental factor acquisition unit includes an infrared detection mechanism, or both the infrared detection mechanism and a photographing mechanism. By means of the infrared detection mechanism, it is possible to acquire the one or more environmental factors at low cost with its working effect being basically not affected by light in the environment.

In some embodiments of the present disclosure, the lighting control module includes a liquid crystal lens and a liquid crystal control unit, for example.

The liquid crystal lens is provided on a light-exiting surface of the lighting module, for example.

The liquid crystal control unit is configured to control liquid crystal in the liquid crystal lens to be deflected such that light passing through the liquid crystal lens is deflected at a desired angle to reach the target illumination area.

In this embodiment of the present disclosure, the liquid crystal molecules in the liquid crystal lens are driven to be deflected such that the liquid crystal lens is equivalent to a prism capable of refracting light rays, thereby controlling the lighting module such as a light source in the lighting module to illuminate according to the illumination demand. Compared with a mechanical control mode in the related art, the structure according to this embodiment is simpler and the deflection of the liquid crystal molecules can be completed in milliseconds. Thus, the response speed is faster and the present disclosure has very high practical value.

In some embodiments of the present disclosure, the liquid crystal lens may have a structure as shown in FIG. 2, which includes a plurality of sub-units 201. The lighting control module drives liquid crystal molecules of each of the sub-units 201 to be deflected. By arranging properly a distribution density of the sub-units 201, a control accuracy of the liquid crystal control unit can be improved.

A liquid crystal lens (LC lens), which realizes a desired deflection direction of liquid crystal and thus a special spatial refractive index profile in response to the application of a specific electric field using electro-optic effect of liquid crystal and is capable of achieving millisecond-scale control of a travelling direction of light rays emitted from the lighting device, is a non-mechanical light control device. The LC lens is placed behind the light sources of the lighting device, such as an array of the light sources, an electric field distribution loaded on the LC lens is determined in conjunction with the one or more environmental factors acquired by detection mechanisms such as a camera and a sensor, and the deflection of liquid crystal is controlled by the electric field to form the desired spatial refractive index profile, thereby precisely controlling a focusing distance and a travelling direction of light rays emitted from the array of the light sources of the lighting device to conform with environmental factors such as obstacles, corners, ramps, water accumulation, pedestrians, animals, etc. When the lighting device provided in the present disclosure is applied to a vehicle, the deflection of the liquid crystal lens may be controlled in conjunction with traffic information fed back by the driver assistance system.

The type and operating principle of the LC lens are not limited in the embodiments of the present disclosure and they are suitable so long as an ideal refractive index profile can be achieved using calculated voltage data.

In specific embodiments of the present disclosure, light sources of the lighting device are arranged in the form of a predetermined array, for example.

In some embodiments of the present disclosure, the lighting device may be applied to a vehicle. And in this case it may be referred to as a lighting device for a vehicle.

In specific embodiments of the present disclosure, the vehicle may be a car or a train or an electric car or a motorcycle or a bicycle or the like.

In a specific embodiment of the present disclosure, when the vehicle is a car, the lighting control module includes a liquid crystal lens. In this embodiment, the liquid crystal lens is applied to headlamps to realize a desired deflection direction of liquid crystal and thus a special spatial refractive index profile in response to the application of a specific electric field using an electro-optic effect of liquid crystal, thereby achieving the control of a travelling direction of light rays emitted from the headlamps. In the related art, a well-developed sensing detector in the automobile industry is used to accurately grasp oncoming traffic condition at night. The combination of the light control effect of the liquid crystal and the traffic information fed back by the sensing detector may provide an intelligent lighting system of the automobile's lamps, which accurately control a focusing distance and a travelling direction of light emitted from the array of the light sources of the headlamps to conform with complex road conditions such as obstacles, corners and ramps. As a result, it is able to provide the driver with convenient, safe and civilized intelligent lighting experiences.

When the lighting device is applied to a vehicle, the light sources of the vehicle are arranged in an array so as to cooperate with the dimming effect of the LC lens. The arrangement may be flexibly designed depending on the shape of the appearance of the headlamps, manufacturing cost, etc.

The type of the light sources of the lighting device may be, but not limited to, a Light Emitting Diode (LED), and can be flexibly designed as desired.

The LC lens shown in FIG. 2 is placed behind the array of the light sources, i.e., along the light-exiting side of the light sources of the lighting device.

When the lighting device is applied to a vehicle, a relevant technique (a light-sensitive control system consisting of a camera, a sensor and a driver assistance system) in the automobile industry is used to obtain oncoming or roadside traffic information (humans, animals, construction obstacles, vehicles, etc.) and feed it back to an environmental factor calculation unit in real time. The environmental factor calculation unit may be, but not limited to, a microcontroller, and calculates an appropriate illumination area of the lighting device based on the traffic information. For example, in the case where there is an oncoming vehicle, the suitable illumination area calculated by the environmental calculating unit is an area other than an area where the oncoming vehicle is located. In this way, it is possible to prevent dazzling the driver in the oncoming vehicle and also to provide a broad view of road conditions so as to ensure safe driving.

The liquid crystal control unit can further convert the appropriate illumination area data into corresponding voltage data which will be applied to control electrodes of the liquid crystal lens. When the lighting device is applied to a vehicle, the liquid crystal lens causes deflection under the applied voltage to form a desired refractive index profile, thereby ideally controlling the emitted light rays. Eventually, the light rays will not reach the areas in which pedestrians and vehicles are present, but illuminates the other areas. With the vehicle travelling forward, road conditions may be changed, and the light-sensitive system continues to detect the road conditions in real time based on an illumination area of the headlamps and continues to calculate a target illumination area so as to achieve the object of real-time online monitoring of the road conditions and real-time adjustment of the illumination area.

In a specific embodiment of the present disclosure, if the one or more environmental factors indicate a state in which there will be one or more oncoming vehicles within a predetermined time period, the target illumination area determined by the processing module is an area to which light rays projected are not directed towards the eyes of one or more drivers in the one or more oncoming vehicles.

Since at night the lighting device for the vehicle emits light rays which are directed towards to the eyes of a driver of another vehicle, it may result in that the driver cannot see the road ahead of him/her clearly, which is likely to cause dangerous events such as car accidents. Therefore, in an alternative embodiment, if the one or more environmental factors acquired by the environmental factor acquisition unit indicate the state in which there will be one or more oncoming vehicles, the lighting control module is controlled such that light rays emitted from the lighting device will not be directed towards the eyes of the one or more drives of the one or more oncoming vehicles.

In the embodiments of the present disclosure, if the one or more environmental factors indicate that there are one or more oncoming pedestrians ahead of the vehicle, the target illumination area determined by the processing module is an area to which light rays projected are not directed towards the eyes of the one or more oncoming pedestrians.

Since at night the lighting device for the vehicle emits light rays which are directed towards to the eyes of a pedestrian, it may result in that the pedestrian cannot see the road ahead of him/her clearly, which is likely to cause dangerous events such as car accidents. Therefore, in an alternative embodiment, if the one or more environmental factors acquired by the environmental factor acquisition unit indicate that there are one or more oncoming pedestrians ahead of the vehicle, the lighting control module is controlled such that light rays emitted from the lighting device will not be directed towards the eyes of the one or more oncoming pedestrians.

In a specific embodiment of the present disclosure, as shown in FIG. 3, if the one or more environmental factors indicate a state in which the vehicle is about to turn a corner within a predetermined time period, the target illumination area determined by the processing module is an area which conforms with a bending trend of the road. As shown in FIG. 3, the target illumination area is changed from a first range 302 that deviates from the road to a second range 303 that conforms with the road, for example.

The environmental factors may include, but not limited to, the above-mentioned conditions. For example, the one or more environmental factors may also indicate that the vehicle is in other complex road conditions such as travelling uphill or downhill. And in these conditions, an area may be selectively illuminated based on the specific road conditions.

In some embodiments of the present disclosure, if the one or more environmental factors indicate a state in which the vehicle is about to travel uphill or downhill within a predetermined time period, the target illumination area determined by the processing module is an area which conforms with an uphill or downhill trend of the road. If the one or more environmental factors indicate that the vehicle is travelling uphill or downhill, the light in the target illumination area will move upward or downward along with the change in a vertical height of the road.

Meanwhile, the present disclosure provides a vehicle including the lighting device provided in any of the embodiments of the present disclosure.

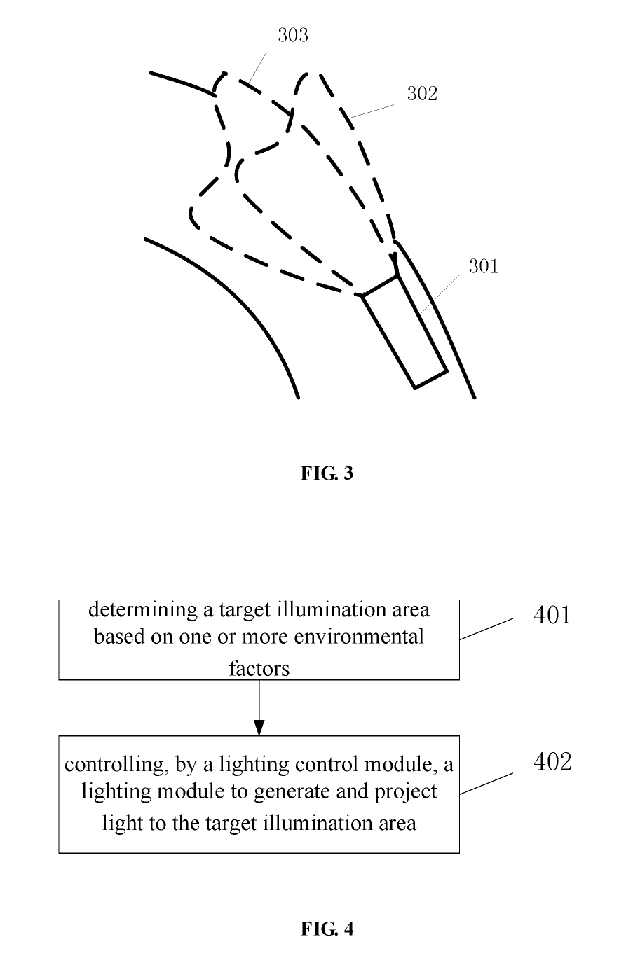

Further, the present disclosure provides a lighting method, which includes the following steps as shown in FIG. 4:

step 401: determining a target illumination area based on one or more environmental factors; and

step 402: controlling, by a lighting control module, a lighting module to generate and project light to the target illumination area.

In some embodiments of the present disclosure, the step of determining the target illumination area based on the one or more environmental factors includes steps of acquiring the one or more environmental factors; and calculating the one or more environmental factors to determine the target illumination area.

In some embodiments of the present disclosure, the lighting control module includes a liquid crystal lens provided on a light-exiting surface of the lighting module; and the step of controlling, by the lighting control module, the lighting module to generate and project light to the target illumination area includes: controlling liquid crystal in the liquid crystal lens to be deflected such that light passing through the liquid crystal lens is deflected at a desired angle to reach the target illumination area.

In some embodiments of the present disclosure, the step of acquiring the one or more environmental factors includes: detecting the one or more environmental factors by infrared light rays.

In some embodiments of the present disclosure, the step of acquiring the one or more environmental factors includes: photographing the one or more environmental factors by means of a photographing mechanism.

In some embodiments of the present disclosure, the liquid crystal lens includes a plurality of sub-units, and the step of controlling the lighting module to project the light to the target illumination area comprises driving liquid crystal molecules of each of the sub-units to be deflected such that the light is projected to the target illumination area.

In some embodiments of the present disclosure, the method may be applied to a lighting device for a vehicle.

In some embodiments of the present disclosure, if the one or more environmental factors indicate a state in which there will be one or more oncoming vehicles within a predetermined time period, the determined target illumination area is an area to which light rays projected are not directed towards the eyes of one or more drivers in the one or more oncoming vehicles.

In some embodiments of the present disclosure, if the one or more environmental factors indicate that there are one or more oncoming pedestrians ahead of the vehicle, the determined target illumination area is an area to which light rays projected are not directed towards the eyes of the one or more oncoming pedestrians.

In some embodiments of the present disclosure, if the one or more environmental factors indicate a state in which the vehicle is about to turn a corner within a predetermined time period, the target illumination area is an area which conforms with a bending trend of the road.

The environmental factors may include, but not limited to, the above-mentioned conditions. For example, the one or more environmental factors may also indicate that the vehicle is in other complex road conditions such as travelling uphill or downhill. And in these conditions, an area may be selectively illuminated based on the specific road conditions.

In some embodiments of the present disclosure, if the one or more environmental factors indicate a state in which the vehicle is about to travel uphill or downhill within a predetermined time period, the target illumination area determined by the processing module is an area which conforms with an uphill or downhill trend of the road. As can be seen from the above, the lighting device and method provided in the present disclosure are capable of determining the target illumination area based on the one or more environmental factors and changing the light-exiting direction of light emitted from the light source to allow the light rays to reach the target illumination area, thereby making it possible to ensure that the illumination state conforms with the needs and improve the flexibility and safety of illumination. In the embodiments of the present disclosure, the liquid crystal lens is applied to the lighting device. As a result, it is able to quickly change the light-exiting direction by controlling the voltage of the power supply.

It shall be understood that the multiple embodiments described in the specification of the present disclosure are for illustration and explanation of the present disclosure only, and are not intended to limit it. In the case of no conflict, the embodiments and features therein of the present disclosure may be combined with each other.

Obviously, those skilled in the art may make changes and variations to the present disclosure without departing from the spirit and scope of the present disclosure. In this way, if such changes and variations fall within the scope of the claims and equivalents thereof, they are intended to be encompassed within the present disclosure.

1. A lighting device, comprising:
a lighting module configured to generate light required for illumination;
a processing module configured to determine a target illumination area based on one or more environmental factors around the lighting device; and
a lighting control module configured to project light emitted from the lighting module to the target illumination area.

2. The device according to claim 1, wherein the processing module comprises:
an environmental factor acquisition unit configured to acquire the one or more environmental factors; and
an environmental factor calculation unit configured to calculate the one or more environmental factors so as to determine the target illumination area.

3. The device according to claim 2, wherein the environmental factor acquisition unit comprises at least one of an infrared detection mechanism, an ultrasonic detection mechanism and a photographing mechanism.

4. The device according to claim 1, wherein the lighting control module comprises:
a liquid crystal lens provided on a light-exiting surface of the lighting module; and
a liquid crystal control unit configured to control liquid crystal in the liquid crystal lens to be deflected such that light passing through the liquid crystal lens is deflected to reach the target illumination area.

5. The device according to claim 4, wherein the liquid crystal lens comprises a plurality of sub-units, and the lighting control module drives liquid crystal molecules of each of the sub-units to be deflected.

6. The device according to claim 5, further comprising light sources arranged in the form of an array.

7. A lighting device for a vehicle, comprising:
a lighting module configured to generate light required for illumination;
a processing module configured to determine a target illumination area based on one or more environmental factors around the lighting device for the vehicle; and
a lighting control module configured to project light emitted from the lighting module to the target illumination area.

8. The device according to claim 7, wherein the processing module comprises:
an environmental factor acquisition unit configured to acquire the one or more environmental factors; and
an environmental factor calculation unit configured to calculate the one or more environmental factors so as to determine the target illumination area.

9. The device according to claim 8, wherein the environmental factor acquisition unit comprises at least one of an infrared detection mechanism, an ultrasonic detection mechanism and a photographing mechanism.

10. The device according to claim 7, wherein the lighting control module comprises:
a liquid crystal lens provided on a light-exiting surface of the lighting module; and
a liquid crystal control unit configured to control liquid crystal in the liquid crystal lens to be deflected such that light passing through the liquid crystal lens is deflected to reach the target illumination area.

11. The device according to claim 10, wherein the liquid crystal lens comprises a plurality of sub-units, and the lighting control module drives liquid crystal molecules of each of the sub-units to be deflected.

12. The device according to claim 11, further comprising light sources arranged in the form of an array.

13. The device according to claim 7, wherein the one or more environmental factors indicate at least one of a state in which there will be one or more oncoming vehicles within a predetermined time period, a state in which there are one or more oncoming pedestrians ahead of the vehicle, a state in which the vehicle is about to turn a corner within a predetermined time period and a state in which the vehicle is about to travel uphill or downhill within a predetermined time period;
if the one or more environmental factors indicate the state in which there will be one or more oncoming vehicles within the predetermined time period, the target illumination area determined by the processing module is an area to which light rays projected are not directed towards the eyes of one or more drivers in the one or more oncoming vehicles;
if the one or more environmental factors indicate the state in which there are one or more oncoming pedestrians ahead of the vehicle, the target illumination area determined by the processing module is an area to which light rays projected are not directed towards the eyes of the one or more oncoming pedestrians;
if the one or more environmental factors indicate the state in which the vehicle is about to turn the corner within the predetermined time period, the target illumination area determined by the processing module is an area which conforms with a bending trend of the road; and
if the one or more environmental factors indicate the state in which the vehicle is about to travel uphill or downhill within the predetermined time period, the target illumination area determined by the processing module is an area which conforms with an uphill or downhill trend of the road.

14. A vehicle, comprising the lighting device according to claim 1.

15. A lighting method, comprising steps of:
determining a target illumination area based on one or more environmental factors; and
controlling, by a lighting control module, a lighting module to generate and project light to the target illumination area.

16. The method according to claim 15, wherein the step of determining the target illumination area based on the one or more environmental factors comprises steps of:
acquiring the one or more environmental factors; and
calculating the one or more environmental factors to determine the target illumination area.

17. The method according to claim 15, wherein the lighting control module comprises a liquid crystal lens provided on a light-exiting surface of the lighting module;
and the step of controlling, by the lighting control module, the lighting module to generate and project light to the target illumination area comprises:
controlling liquid crystal in the liquid crystal lens to be deflected such that light passing through the liquid crystal lens is deflected to reach the target illumination area.

18. The method according to claim 16, wherein the step of acquiring the one or more environmental factors comprises:
detecting the one or more environmental factors by infrared light rays.

19. The method according to claim 16, wherein the step of acquiring the one or more environmental factors comprises:
photographing the one or more environmental factors by means of a photographing mechanism.

20. The method according to claim 17, wherein the liquid crystal lens comprises a plurality of sub-units, and the step of controlling the lighting module to project the light to the target illumination area comprises driving liquid crystal molecules of each of the sub-units to be deflected such that the light is projected to the target illumination area.

21-22. (canceled)
